(19) United States
(12) Patent Application Publication
(10) Pub. No.: US 2011/0019204 A1
(43) Pub. Date: Jan. 27, 2011

(54) Optical and Illumination Techniques for Position Sensing Systems

(75) Inventor: Simon James Bridger, Auckland (NZ)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: Next Holding Limited, Auckland (NZ)

(21) Appl. No.: 12/842,259

(22) Filed: Jul. 23, 2010

(30) Foreign Application Priority Data
Jul. 23, 2009 (AU) 2009903426
Jul. 23, 2009 (AU) 2009903427
Jul. 23, 2009 (AU) 2009903428

(51) Int. Cl. G01B 11/14; G02B 27/14

(52) U.S. Cl. 356/614; 359/629

(57) ABSTRACT

An optical unit includes a body, at least one lens, and a sensor. An optical member can be used to reflect and/or refract light within the body and onto the sensor, with the result that the overall length of the optical unit can be reduced. When positioned at a corner or another location relative to a touch area, the optical unit will have a wider view than a unit with a longer overall length. An integrated optical unit can be used at one or more locations to provide stereo imaging. The integrated optical unit can include optics that route light to and/or from the optical unit through a single aperture of the optical unit but along different optical paths. The light routed along different paths can be routed to a single sensor within the optical unit so that the sensor can image different fields of view of the touch area.

### PRIORITY CLAIM

The present application claims priority to Australian Provisional Patent Application No. 2009903426, filed 23 Jul. 2009 by Simon Bridger and entitled “An Optical Device Comprising a Reflex Mirror,” which is incorporated by reference herein in its entirety; the present application also claims priority to Australian Provisional Patent Application No. 2009903427, filed 23 Jul. 2009 by Simon Bridger and entitled “An Optical Device Comprising Reflective and Refractive Surfaces,” which is incorporated by reference herein in its entirety; the present application also claims priority to Australian Provisional Patent Application No. 2009903428, filed 23 Jul. 2009 by Simon Bridger and entitled “A Stereo Optical Device,” which is incorporated by reference herein in its entirety.

### BACKGROUND

Touch-enabled displays and other devices that rely on detection of a position of one or more objects (such as a stylus, a finger or fingers) relative to a panel have become increasingly popular. For example, one type of touch-enabled display features one or more image sensors used to determine the position of an object (or objects) relative to a display panel. The image sensors may be used to detect interference with a pattern of light above the panel, such as shadows cast on a retroreflective border of the display area and/or by directly imaging the object. Oftentimes the image sensors are included in optical units that also provide illumination (such as infrared or other illumination), with the optical units positioned at corners of the display.

Systems that rely on image sensors typically use a bezel or other structure along one or more edges of the touch screen or area. Due to the size of the sensors and related components, the bezel will extend outward from the actual surface of the touch area and will be characterized as adding a border having a width and height to the otherwise-flat panel. In at least some applications, there is a desire for a screen or touch area that is as close to “flat” or “borderless” as possible.

### SUMMARY

Embodiments configured in accordance with one or more aspects discussed below can allow for position detection systems having smaller and/or simpler arrangements of optical units. In one embodiment, an optical unit includes a body, at least one lens, and a sensor. An optical member within the optical unit can be used to reflect and/or refract light within the body and onto the sensor, with the result that the overall length of the optical unit can be reduced. When the optical unit is positioned at a corner or another location relative to a touch area (such as at a corner of a display), the optical unit will have a wider view than an optical unit with a longer overall length at that same position.

Embodiments also include position detection systems comprising one or more integrated optical units capable of providing stereo detection capabilities. Stereo detection can be used to enhance the sensitivity of a position detection system and/or to increase the total number of points that can be identified based on interference with light in a touch area. In one embodiment, rather than using multiple optical units for stereo detection at one or more locations around the touch area (such as pairs of optical units at the corners), a single, integrated optical unit can be used at the location(s), with the integrated optical unit including optics that route light to and/or from a common sensor but along different optical paths. The light routed along different paths can be routed to a single sensor within the optical unit so that the sensor can, in effect, image different fields of view of the touch area as light impinges on the sensor at different angles.

These illustrative embodiments are mentioned not to limit or define the limits of the present subject matter, but to provide examples to aid understanding thereof. Illustrative embodiments are discussed in the Detailed Description, and further description is provided there. Advantages offered by various embodiments may be further understood by examining this specification and/or by practicing one or more embodiments of the claimed subject matter.

### BRIEF DESCRIPTION OF THE DRAWINGS

A full and enabling disclosure is set forth more particularly in the remainder of the specification. The specification makes reference to the following appended figures.

FIG. 1 is a diagram showing an illustrative touch screen system.

FIGS. 2A-2B are each a diagram showing an embodiment of an optical unit using an optical member to direct light within the optical unit.

FIG. 3 is a diagram showing an additional embodiment of an imaging device using an optical member to direct light within the optical unit

FIGS. 4A-4D illustrate examples of optical members that can be used within imaging devices.

FIG. 5 is a diagram showing an illustrative optical arrangement for a stereo optical unit.

FIG. 6 is a diagram showing an illustrative side view of an embodiment of a stereo optical unit.

FIG. 7 is a top view of an embodiment of a stereo optical unit.

### DETAILED DESCRIPTION

Reference will now be made in detail to various and alternative exemplary embodiments and to the accompanying drawings. Each example is provided by way of explanation, and not as a limitation. It will be apparent to those skilled in the art that modifications and variations can be made. For instance, features illustrated or described as part of one embodiment may be used on another embodiment to yield a still further embodiment. Thus, it is intended that this disclosure includes modifications and variations as come within the scope of the appended claims and their equivalents. In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure the claimed subject matter.

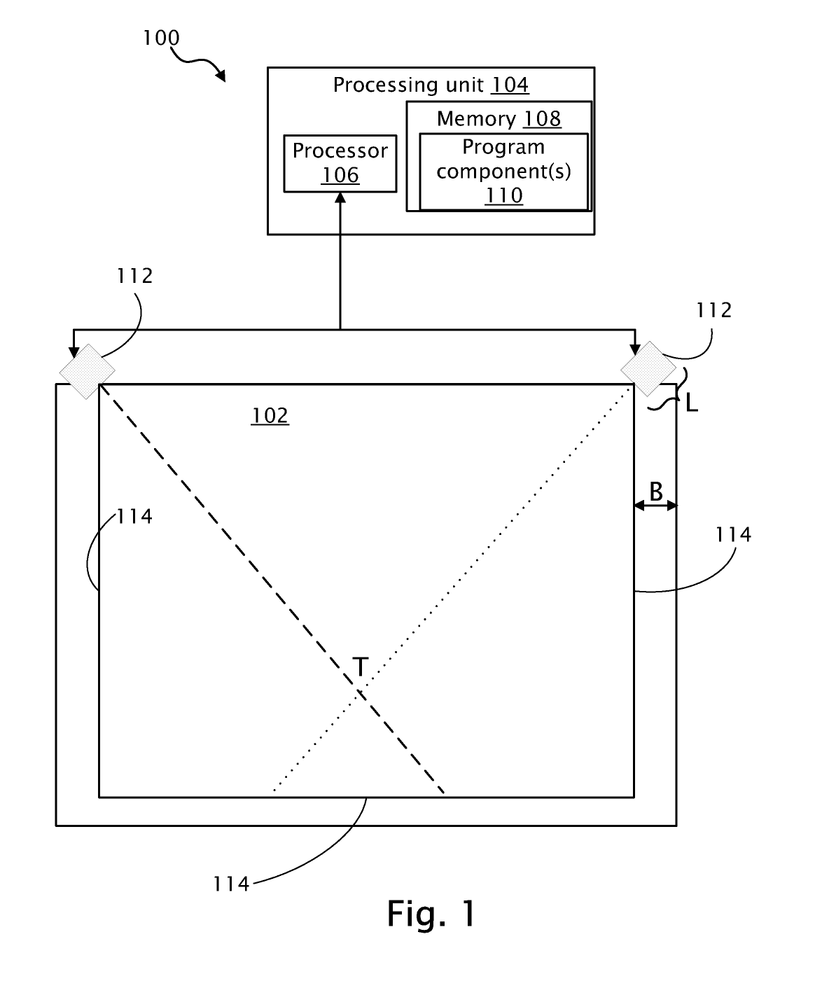

FIG. 1 is a diagram showing an illustrative touch screen system 100. In this example, a touch area corresponds to a display device 102 interfaced to a processing unit 104. Display device 102 may comprise an LCD, LED, or other panel or another display technology. Processing unit 104 includes a processor 106 and a memory 108. Memory 108 features one or more program components 110 that configure the processor to obtain image data from one or more imaging devices and to use the image data to determine a position of one or more objects. System 100 may comprise a desktop, laptop, or tablet computing system or another computing device. Although the touch area in this example is provided by a display panel, embodiments include systems that detect position relative to panels or other structures. For example, a pad or tablet area may be used for position-based inputs, with the pad or tablet mapped to a separate display.

In this example, two optical units 112 are positioned at corners of display 102. Each optical unit 112 comprises a sensor and an illumination source. The illumination source is used to direct energy, such as infrared light, towards a reflective surface 114 along edges of the touch area. The object at touch point T casts shadows that can be detected using the imaging devices and program component(s) 110 may use triangulation of shadows cast by an object when the object approaches or touches a surface of display 102 at touch point T. As another example, program component(s) 110 may utilize image processing and analysis techniques to determine a position of the object in a space above display 102 and use the determined position for control purposes.

In this example, reflective surface 114 is positioned alongside and/or is formed as part of a bezel 116 which surrounds display 102. As can be seen, bezel 116 has a width B which in this example is sized based on a length L of optical unit 112. In this example, optical unit 112 is positioned at the corner of display 102. In order for a thinner bezel to be used (i.e., one in which B is less than shown in FIG. 1) with optical unit 112 at the same position, the length L of optical unit 112 must be decreased.

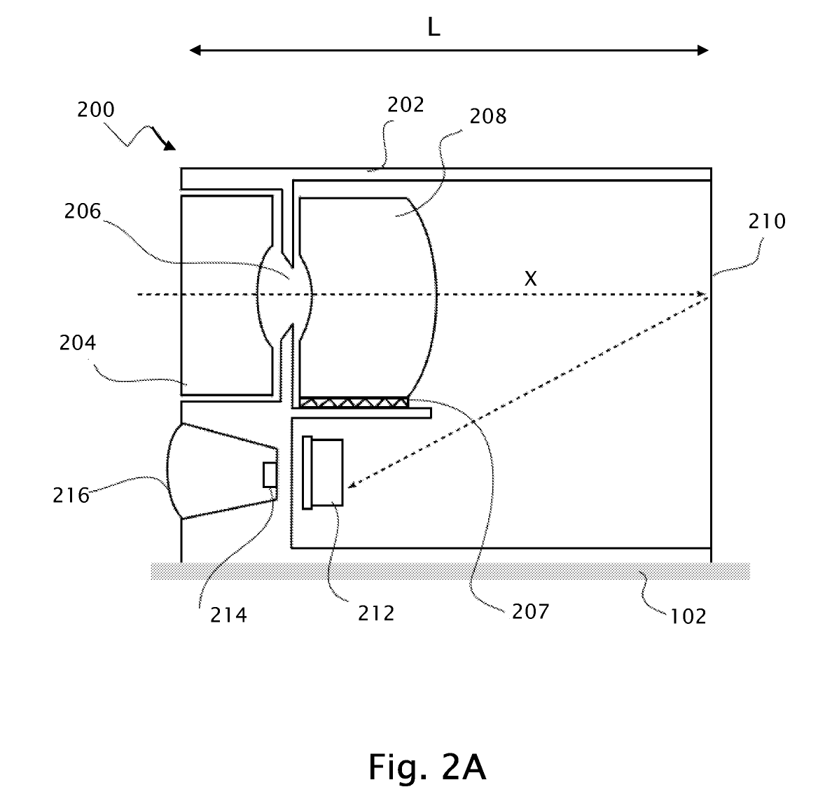

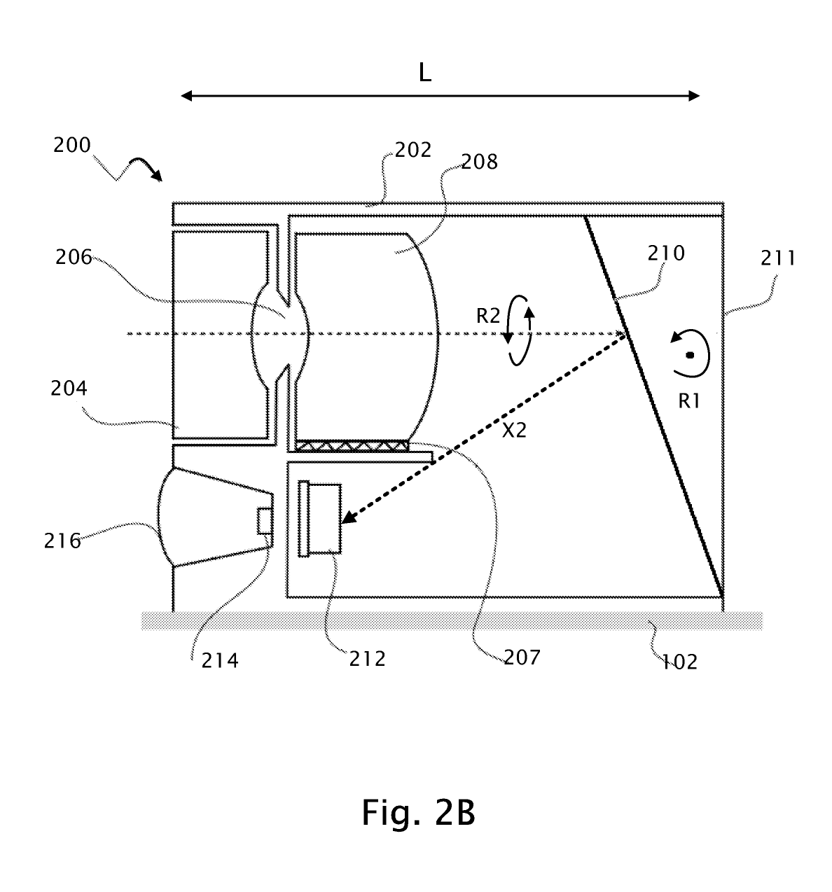

FIG. 2A is a diagram showing an embodiment of an optical unit 200 using an optical member to direct light within the optical unit. Specifically, optical unit 200 is designed so that the sensor is not collinear with the aperture of optical unit 200—instead, one or more optical members are used to redirect light from a first path that passes through the aperture onto a second, different, path that intersects the sensor. In practice, light may be directed onto intermediate paths between the first and second paths. As noted below, the member(s) may be separate items within the body of the optical unit or even one or more portions of the optical unit itself.

In this example, optical unit 200 is shown positioned on a surface of display 102, though of course it could be positioned at an edge of display 102. In this example, optical unit 200 includes a body 202 that defines a interior of the optical unit, a window lens 204, and a main lens 208. Window lens 204 guides light along path X through aperture 206 in body 202 and toward main lens 208 (which is attached to body 202 by glue 207 or another attachment mechanism).

Main lens 208 focuses light to a reflective surface 210 that redirects the light to sensor 212. The light may be from an external illumination system, ambient lighting, and/or even from an object being detected. Additionally or alternatively, a light source 214 (such as a light emitting diode (LED)) can be used along with source lens 216 to direct light into a touch area. For instance, light along path X may represent light reflected by an object of interest and/or may represent a pattern of retroreflected light, including one or more shadows cast by the object.

Reflective surface 210 may comprise a mirror or reflective coating on the rear surface of body 202. In some embodiments, reflective surface 210 is a separate element from body 202 and optical unit 200 includes an adjustment mechanism (not shown) that can be used to adjust the position of reflective surface 210. For example, a screw or a structural member can be used to move reflective surface 210 towards and away from the sensor (i.e. along the y-axis as illustrated in FIGS. 2A-2B). As another example, the surface may be rotated along one or more degrees of freedom as shown in FIG. 2B. By rotating the surface, the angle at which light X contacts reflective surface 210 can be adjusted.

As shown at R1 in FIG. 2B, reflective surface 210 has been rotated about an axis perpendicular to the plane of the page. This has adjusted the path of incoming light as shown at X2. In addition or instead of rotating as shown at R1, reflective surface 210 could be rotated about another axis, such as about an axis of incoming light or about an axis perpendicular to surface 210 as shown at R2. The axis of incoming light and the axis perpendicular to the surface could be the same, or the axes could be differ, and rotation could be about either or both axes. This may, for example, allow for variations in reflective surface 210 to be used in tuning the path and other characteristics of light X2 directed towards sensor 212.

The placement of surface 210 may be adjusted during assembly and then fixed into place. For example, optical unit 200 can be placed at a corner or another location relative to a touch area. Surface 210 can be fine-tuned to ensure that sensor 212 captures the desired field of view from the particular location at which optical unit 200 has been placed. Additionally, the overall length L of optical unit 200 can be decreased relative to an optical unit in which lens 208 is arranged serially with sensor 212. By positioning sensor 212 and lens 208 in a stacked formation, the required length can be reduced. Although in this example lens 208 is above sensor 212, the arrangement could be reversed—window lens 204, aperture 206, and main lens 208 could be in the lower portion of body 202 and sensor 212 (along with light source 214 and lens 216, if used) could be located above items 204, 206, and 208. Sensor 212 could be located elsewhere as well—for example, sensor 212 could be located along the bottom or top of the optical unit.

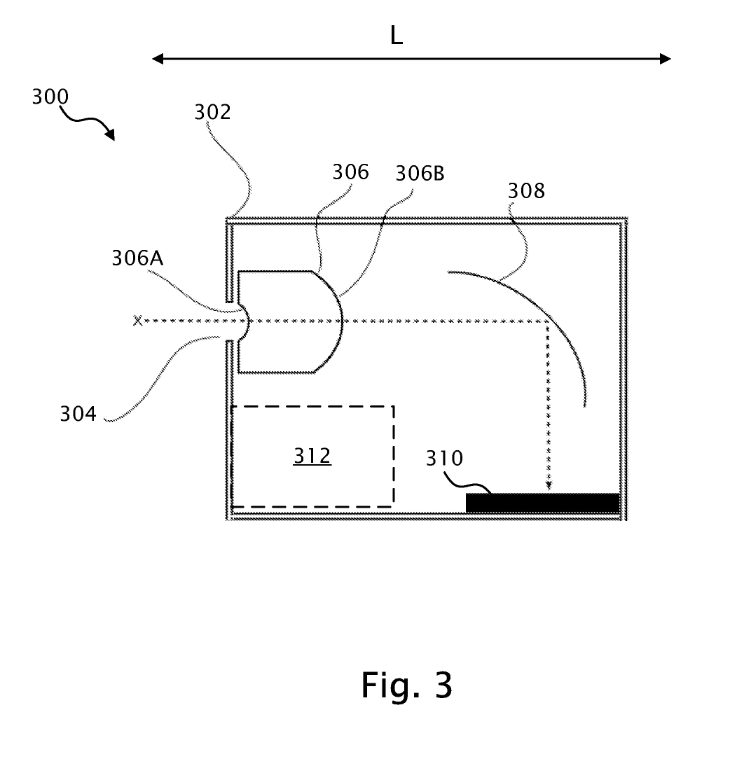

FIG. 3 is a diagram showing an embodiment of an optical unit 300 that uses an optical member to direct light within the optical unit so that the sensing device need not be collinear with the aperture. In this example, optical unit 300 includes a body 302 that defines an aperture 304. Light traveling along path X enters aperture 304 and passes to lens 306, which includes two optically active surfaces 306A and 306B. Surfaces 306A and 306B are refractive and serve to distort the incoming image as it passes through lens 306 and is reflected by reflecting member 308 onto sensor 310, which is located along the bottom of the optical unit. Reflecting member 308 may itself be optically active or may simply reflect the incoming light. As shown in FIG. 3, an area 312 of the interior of optical unit 300 may be used for an illumination device; alternatively, external illumination sources can be used.

The distortion introduced by the optically active surfaces can be used to focus an image, stretch the image, compress the image, or otherwise manipulate the image as represented by incoming light to aid in detection using sensor 310. The optically active surfaces may be convex, concave, and/or otherwise formed to provide desired optical effects. The surfaces and members can be formed using any suitable material including (but not limited to) glass or plastic.

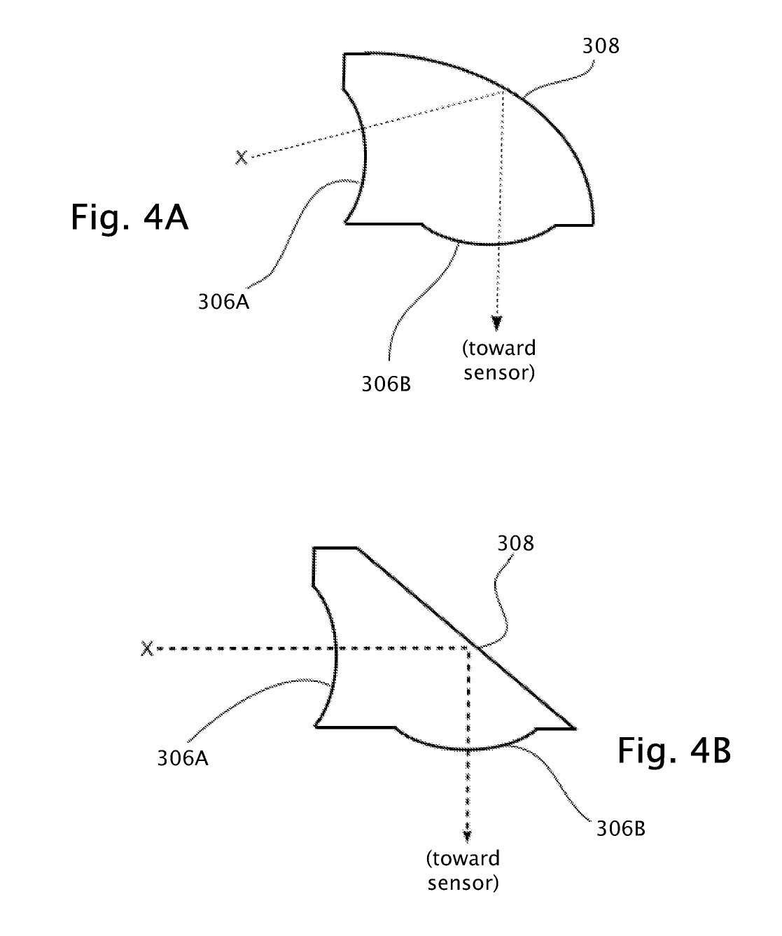

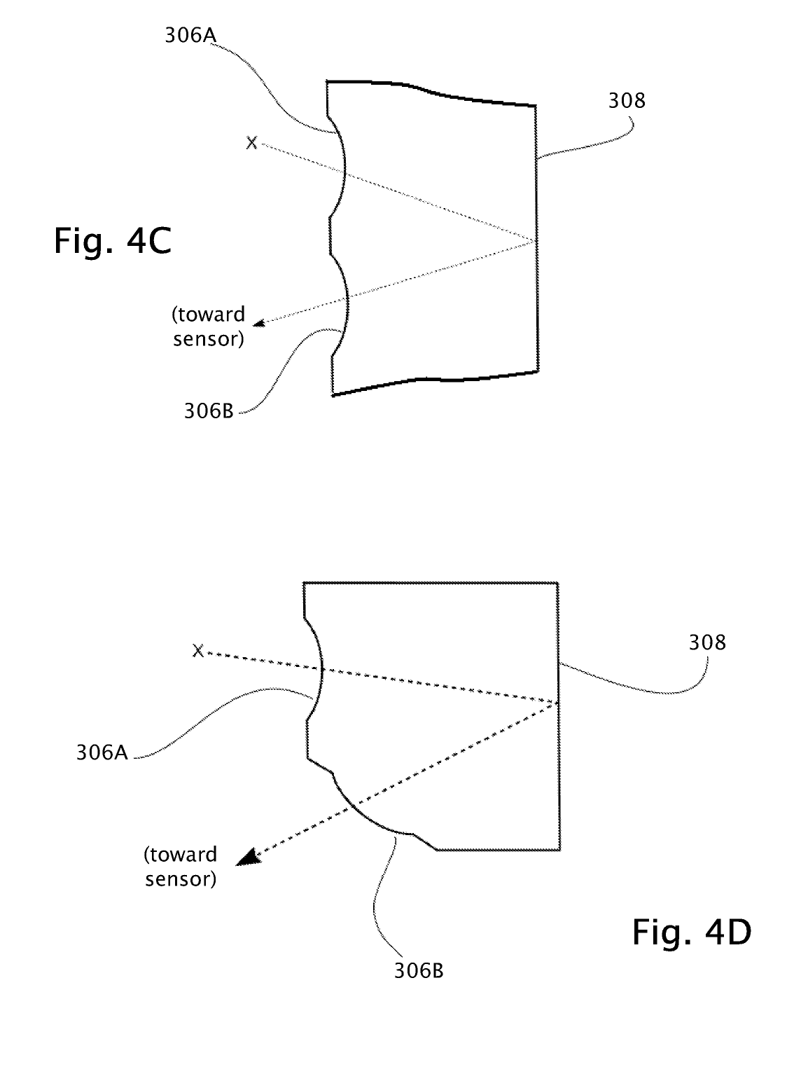

FIGS. 4A-4D illustrate examples of optical members that can be used within imaging devices, with different arrangements of lenses and reflecting members. In each example, the path X of light is shown but for ease of explanation the body and remaining components of optical unit 300 are not shown. Additionally, in these examples the optically active surfaces and mirror are provided by a single optical member. Thus, rather than using a separate lens and reflecting member (e.g., lens 306 and reflector 308 of FIG. 3), in these embodiments the single optical member can be configured with appropriate surfaces 306A, 306B, and 308 and then placed at a proper location within the optical unit.

In FIG. 4A, the member includes a concave surface 306A and a curved rear surface 308 that directs light out a convex surface 306B and towards the sensor. Use of a curved reflecting surface can magnify or reduce the image or otherwise introduce distortions in a controlled manner. In FIG. 4B, light enters at the concave surface 306A and exits at convex surface 306B but is reflected by a planar rear wall.

In FIG. 4C, light enters at concave surface 306A formed in a first portion of a front face of the optical member and is reflected by rear surface 308 back towards the front face of the optical member. In this example, light exits from another concave surface 306B. In FIG. 4D, light enters at the front face through concave portion 306A and exits a convex portion 306B.

Optical members such as those shown in FIGS. 4A-4D could be manufactured by using plastic molding to obtain sheets of optical devices, with the individual devices separated for use in optical units. As another example, plastic or another material could be extruded in a shape having a cross-section, such as the cross-sections of FIGS. 4A-4D or another suitable form, and then the extruded material could be cut along the cross-sections into individual optical units. Reflective surfaces could be achieved using, for example, a reflective coating on the plastic or other material forming the optical members. The optically-active surfaces can be achieved in any suitable manner and the particular contours shown here are for purposes of example only.

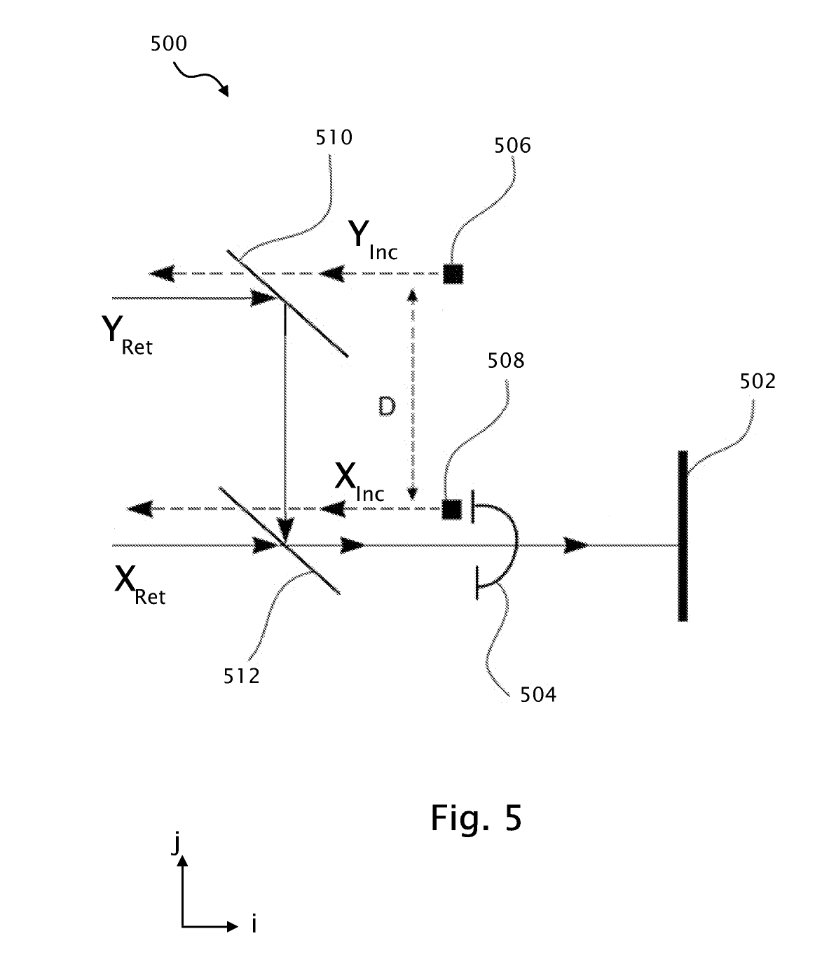

FIG. 5 is a diagram showing a top view of an illustrative optical arrangement 500 for a stereo optical unit. Generally, a stereo optical unit can comprise an aperture, a lighting system that provides at least two spaced apart point sources, and a light receiving sensor. In use, the spaced apart point sources can be used to transmit light at separate times and/or the light can be varied in another manner. Light from the point sources is emitted into the touch area to be reflected back, with suitable optics included in the stereo optic unit so that reflected-back light from the different sources impinges the sensor. The lighting system may be included in the body of the stereo optical unit. However, in additional embodiments an external lighting system can be used in addition to or instead of a lighting system included in the body of the stereo optical unit.

In practice, the beam splitter and mirror can be positioned between the aperture and the lens, with the mirror positioned to redirect light traveling along a first path that intersects the mirror onto a second path that intersects the beam splitter. The beam splitter is configured to redirect light traveling along the second path onto a third path that intersects the lens. The beam splitter also passes light on a fourth path that intersects the beam splitter and the lens. Thus, at least some light on both the first and fourth paths can ultimately reach the lens (and subsequently the sensor).

In the arrangement shown in FIG. 5, the sensor is shown at 502 and can comprise a line or area sensor. A lens 504 is used to focus light onto sensor 502. In this example, the lighting system uses two separate sources 506 and 508 separated by a distance D along the width of the sensor (the j-axis in this example, with the sensor length along the i-axis and the height of the sensor along the k-axis perpendicular to the page). For example, sources 506 and 508 may comprise LEDs or other lighting devices. As another example, a single source can be used, with light from the single source providing an effect of two point sources via a tilt mirror, wedged window, and/or other optical components. In this example, a lens assembly comprising a single lens 504 is used. Embodiments can use lens assemblies that include multiple lenses. The lenses can be of any suitable type or material.

Optical arrangement 500 further includes a mirror 510 and a beam splitter 512. Because FIG. 5 is a top view of the optical unit all components are shown together, but it should be understood that the light-emitting components (i.e. 506 and 508 in this example) may be in different planes than the light-receiving components (502, 504, 510, and 512 in this example). For instance, sources 506 and 508 may be positioned above (or below) mirror 510 and beam splitter 512 so that the emitted light travels over (or under) those components. In some embodiments, light sources and/or suitable optical members are used so that light X_{inc} and Y_{inc} is emitted from the same aperture that receives the reflected light.

Sources 508 and 506 emit incident light X_{inc} and Y_{inc} respectively and the light travels out of the optical unit and is reflected back by a reflective medium (such as the retroreflective border shown in FIG. 1). When returned light Xᵣₑₜ (corresponding to reflection of X_{inc}) and returned light Yᵣₑₜ (corresponding to reflection of Y_{inc}) return to the optical unit, the light Xᵣₑₜ travels through the splitter 512 to the lens 504, and passes on to the sensor 502. When the light Yᵣₑₜ returns, it is first reflected by the mirror 510 towards the splitter 512. Splitter 512 directs light Yᵣₑₜ toward lens 504 and sensor 502. In one embodiment, the length of mirror 510 is equal to twice the distance between point sources 506 and 508 (i.e., the length of mirror 510 equals 2D).

In one embodiment the light paths are arranged so that the received images through paths X and Y fall on the same area of the sensor. The narrow observation angle property of the retro reflective material ensures that when one LED (or other source) is illuminated, the large majority of the return signal comes back to the corresponding path. When Y_{Inc} is provided using source 506, the received image is through Yᵣₑₜ. When X_{inc} is provided by source 508, the return signal is through Xᵣₑₜ. In this way a camera system is able to effectively have separate images through two separate paths, but without any mechanical shutter arrangement being required to separate them. Instead, the selection is made electrically by controlling the illumination source. The source can be controlled by a processor as part of a detection and sampling routine, for example.

For correct operation of such a retro reflective system the source 506 in the Y path needs to have the same relationship to the optical centre of the system (approximately the lens aperture) as the source 508 has in the X path. This means that source 506 will be displaced further back from mirror 510 than source 508 is from beam splitter 512 by D. Commonly, source 508 will be arranged to be as close a possible to beam splitter 512, whereas source 506 will be D away and behind mirror 510.

In one possible arrangement, due to the different separation of sources 506 and 508, the light X_{inc} and Y_{inc} contacts the reflective medium at different angles, resulting in different patterns of light in the touch area. The different patterns can be used to recognize one touch with a single camera and/or can be used to improve accuracy and capabilities when multiple cameras, each comprising a stereo optical unit, are used.

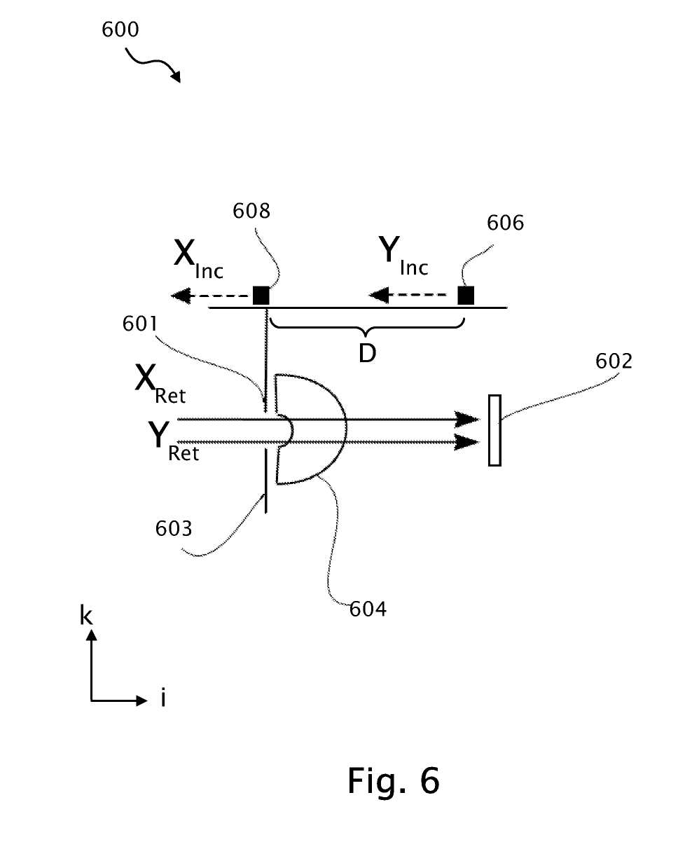

The separation of sources 506 and 508 also results in different reception angles of the reflected light Xᵣₑₜ and Yᵣₑₜ by the sensor 502. This can be seen in FIG. 6, which shows a side view of one illustrative embodiment of a stereo optical unit, with the j+axis pointing into the page. Sources 606 and 608 are above the optical path between sensor 602 and lens 604. As can be seen here, source 606 is further back than source 608 by distance D; thus sources 606 are separated by D along the length of the sensor (i.e., along the i-axis) and also along the width (j-axis) of the sensor (with that separation not visible in FIG. 6 because FIG. 6 is a side view). In this example, the beam splitter and mirror are not shown; these could be included between lens 604 and the aperture defined between members 601 and 603. As shown here lens 604 collects the returned light and directs it along parallel paths to sensor 602, where it could be detected at different sensor portions. Alternatively, the beam splitter and mirror could be omitted, provided the aperture and lens are appropriately configured to capture and route the light returned at different angles.

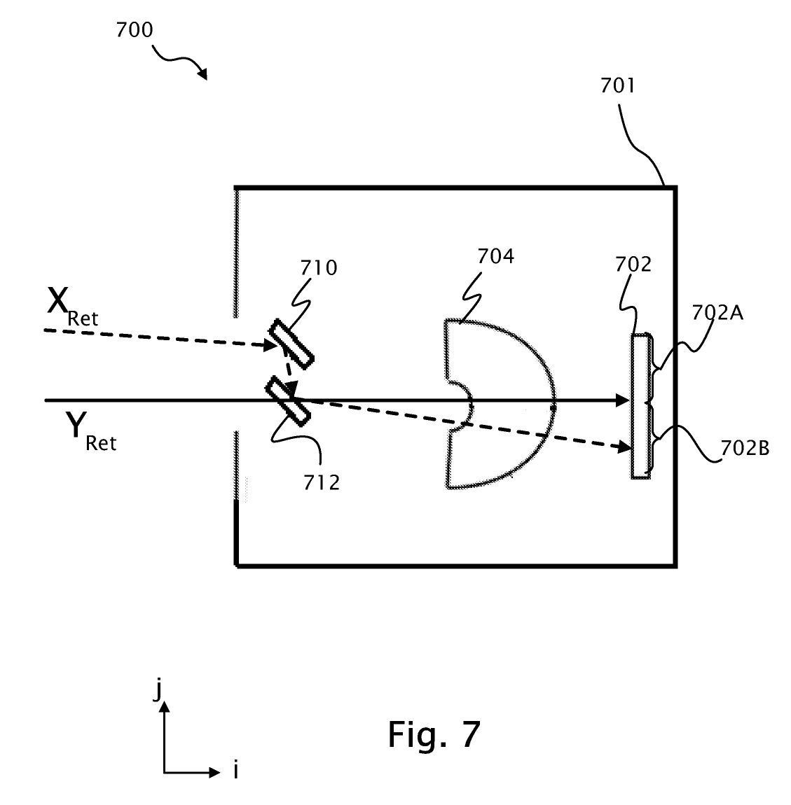

FIG. 7 is a top view of an embodiment of a stereo optical unit, which features a body 701, sensor 702, lens 704, mirror 710, beam splitter 712. The illumination system is not shown, but one or more sources could be above and/or below the components shown here and/or an external illumination system could be used. In the example of FIG. 7, portions 702A and 702B of the sensor 702 are arranged in a strip like manner (e.g., as parallel strips of line sensors or dedicated portions of an area sensor) to facilitate separate detection of the light X_{inc} and Y_{inc}. If light can be received at separate portions of the sensor, then all of the incident light can be shuttered using a single shutter means (e.g., an electromechanical or other device to selectively open and close the aperture of the optical unit). The strip approach could also be used in the embodiment of FIG. 5 and/or the embodiment of FIG. 6.

The light source(s) used to provide incident light X_{inc} and Y_{inc} can also be used to facilitate separation—for example, if separate LEDs are used, the LEDs can be illuminated at different times. As a specific example, returning to FIG. 5, point source 506 may be active while source 508 is not, and vice versa. As another example, different frequencies and suitable filtering can be used to facilitate separation.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed:

1. An optical unit, comprising:
a body that defines an interior of the optical unit;
an aperture defining an opening in the body;
a sensor positioned in the interior;
at least one optical member positioned in the interior; and
a reflective surface within the interior,
wherein the reflective surface is positioned to redirect light from a first path to a second path, the second path different from the first path and intersecting the sensor.

2. The optical unit of claim 1, wherein the first path passes through the aperture.

3. The optical unit of claim 1, wherein the at least one optical member comprises a surface configured to provide a lens effect.

4. The optical unit of claim 3, wherein the at least one optical member comprises a lens and the reflective surface comprises a mirror separate from the lens.

5. The optical unit of claim 3, wherein the at least one optical member comprises a first surface that provides the lens effect and a second surface, the second surface corresponding to the reflective surface that redirects the light from the first path to the second path, the first path intersecting the first surface and passing through a body of the at least one optical member.

6. The optical unit of claim 5, wherein the at least one optical member comprises a third surface, the second path intersecting the third surface.

7. The optical unit of claim 1, further comprising an adjustment mechanism to adjust a position of the reflective surface within the optical unit.

8. The optical unit of claim 1, wherein the reflective surface is included in an interior portion of the body of the optical unit.

9. A stereo optical unit, comprising:
a body that defines an interior of the stereo optical unit;
an aperture defining an opening in the body;
a sensor;
a lens assembly comprising at least one lens positioned between the beam splitter and the sensor;
a mirror; and
a beam splitter,
wherein the beam splitter and mirror are positioned between the aperture and the lens assembly, the mirror positioned to redirect light traveling along a first path that intersects the mirror onto a second path that intersects the beam splitter, and
wherein the beam splitter is configured to redirect light traveling along the second path onto a third path that intersects the lens assembly and is further configured to pass at least some light on a fourth path, the fourth path intersecting the beam splitter and the lens assembly.

10. The stereo optical unit set forth in claim 9, wherein the mirror is positioned to intersect the first path while allowing light on the fourth path to pass to the beam splitter.

11. The stereo optical unit set forth in claim 9, wherein the mirror and beam splitter are positioned to direct light passing through the aperture and reflected from a reflective member at different angles to arrive at different angles at the sensor.

12. The stereo optical unit set forth in claim 10, further comprising an illumination system, the illumination system configured to provide a first point source separated from a second point source by a distance.

13. The stereo optical unit set forth in claim 12, wherein the illumination system comprises a first diode corresponding to the first point source and a second diode corresponding to the second point source.

13. The stereo optical unit set forth in claim 12, wherein the mirror has a length equal to twice the distance between the first and second point sources.

14. The stereo optical unit set forth in claim 12, wherein the first point source and second point source are separated by the distance along a length of the stereo optical unit and along a width of the stereo optical unit.

15. The stereo optical unit set forth in claim 12, wherein the mirror and beam splitter are positioned so that light from the first point source and light from the second point source, as reflected from a reflective member, is directed to different portions of the sensor after entering the aperture.

16. The stereo optical unit set forth in claim 12, interfaced to a processor, wherein the processor directs the illumination system to emit light from the first and second point sources at different times.

17. A position detection system comprising:
a panel defining a touch area;
a first optical unit comprising a body that defines an interior of the optical unit, an aperture defining an opening in the body, a sensor positioned in the interior, at least one optical member positioned in the interior, and a reflective surface within the interior, wherein the reflective surface is positioned to redirect light from a first path within the body of the first optical unit to a second path within the body of the first optical unit, the second path different from the first path and intersecting the sensor; and
a stereo optical unit comprising a body that defines an interior of the stereo optical unit, an aperture defining an opening in the body, a sensor, a lens assembly positioned between the aperture and the sensor, a mirror, and a beam splitter,
wherein the beam splitter and mirror are positioned between the aperture and the lens assembly, the mirror positioned to redirect light traveling along a first path within the body of the stereo optical unit and which intersects the mirror onto a second path within the body of the stereo optical unit and which intersects the beam splitter, and
wherein the beam splitter is configured to (i) redirect light traveling along the second path onto a third path within the body of the stereo optical unit and which intersects the lens assembly and is further configured to (ii) pass at least some light onto a fourth path within the body of the stereo optical unit, the fourth path intersecting the beam splitter and the lens assembly.
